(19) United States
(12) Patent Application Publication
(10) Pub. No.: US 2012/0069184 A1
(43) Pub. Date: Mar. 22, 2012

(54) REAR VIEW DEVICE FOR A MOTOR VEHICLE

(75) Inventor: Philipp Hottmann, Stuttgart (DE)

(73) Assignee: SMR Patents S.a.r.l., Luxembourg (LU)

(21) Appl. No.: 13/234,824

(22) Filed: Sep. 16, 2011

(30) Foreign Application Priority Data
Sep. 17, 2010 (EP) 10177322
Sep. 22, 2010 (EP) 10178378

(51) Int. Cl. H04N 7/18

(52) U.S. Cl. 348/148; 348/E07.085

(57) ABSTRACT

A motor vehicle rear view mirror device with at least one optical sensor is suggested, which is connected to at least one image evaluation circuit board and to at least one display. This optical sensor is connected to the image evaluation circuit board via a receiver circuit board, and the image evaluation board is connected to the display via a receiver circuit board. The connection cables transfer serial data, and the connection length is 1 to 10 m.

### BACKGROUND INVENTION

1. Field of the Invention

The invention is based on priority patent applications EP 10177322.4 and EP 10178378.5 which are hereby incorporated by reference.

2. Description of the Related Art

The invention relates to a rear view device for a motor vehicle, which serves as a replacement rear view mirror, as well as a rear view device, which replaces all mirrors present in the vehicle.

Typically, a side rear view mirror is arranged on each side in the region of the front ends of the front door side panes on motor vehicles, through which mirror the driver of the vehicle can observe the traffic situation behind the vehicle and to the sides of the vehicle, in order to determine whether he can change lanes or turn off, for example. A characteristic of side rear view mirrors of this type is that the angular range visible to the rear is limited, the side rear view mirrors protrude relatively far over the contour of the vehicle, so they cause additional vehicle width and negatively influence the air resistance, and that the operator must look away relatively far from the traffic situation in front of the vehicle, which can lead to dangerous situations.

However, the advantage of a mirror is that the eye must not focus on the close range, but rather that the reflected image is focused by normal remote adjustment of the eye of the operating person.

The replacement of a simple mirror by cameras with different display systems is widely discussed in literature. In the process, the mirror replacement is given prominence, which includes a reduction of the wind resistance, but which has no further advantage for the operator.

A rear view device with a camera for a motor vehicle is known in DE 697 09 810 T9, in which an electronic camera is also provided in every rear view mirror, whose image is transferred to a display in each case, which is arranged on the side of the steering wheel facing the respective rear view mirror. An additional camera can be arranged on the vehicle, which includes the region behind the vehicle, and whose focal length and/or position can be modified for adaptation to particular driving situations and dangerous situations. The images delivered by the cameras can be digitalised, so that vehicles approaching from behind or even vehicles situated at an angle behind the vehicle can be detected, with which there is a danger of collision during a lane change before an overtaking manoeuvre.

DE 100 43 099 A1 discloses a monitoring device of the rearward region of a vehicle by means of at least one video camera. The video camera is arranged on the side of the vehicle facing the opposite lane, and monitors the rearward region of the vehicle. The video camera can facilitate at least two different magnification standards from different perspectives, which are displayed on two monitors or on a monitor with two different image areas. The different magnification standards are automatically selected according to the direction of movement.

A vehicle rear view system with panorama view is known in DE 696 18 192 T3. The rear view system includes at least two image capturing devices on the side, which are arranged in the region of the front mudguard of the vehicle in each case, as well as a central image capturing device in the rear region of the vehicle. The image capturing devices are generally directed behind the vehicle. An image processor receives data signals of the image capturing devices and synthesises a combined image from these data signals, which is displayed on a display in the dashboard.

A camera solution with an active component is known in DE102007054342. The angle of view of the camera system changes, as soon as the indicator is used. Through this, at least one added value is achieved for the operator.

All solutions discussed up to now are prototype solutions, whose implementation in series production can lead to problems. For example, the object, of how the components work together and how data download times have an effect, is not achieved.

### SUMMARY OF THE INVENTION

The object forming the basis of the invention, which is to provide a motor vehicle rear view device, which allows the operator of the vehicle to observe the traffic situation towards the rear at least on both sides of the vehicle, with additional information being made available. The motor vehicle rear view device considerably reduces the air resistance of the vehicle, which allows the data be effectively distributed and processed, without representation problems occurring due to data download times.

This object is achieved with a motor vehicle rear view device, without side rear view mirrors, but with at least one optical sensor, which is connected to at least one image evaluation circuit board and to at least one display, wherein the at least one optical sensor being connected to the image evaluation circuit board via a receiver circuit board, and the image evaluation circuit board being connected via a receiver circuit board to the display, thereby the connection cables are designed for serial data, and the connection length is 1 to 10 m, and the receiver circuit board is connected to the image receiver circuit board, and the display receiver circuit board is connected to the display, whereby the data cables are designed for parallel data transfer over a distance smaller than 100 mm.

The sub-claims are focused on advantageous embodiments and further developments of the motor vehicle rear view device according to the invention.

### BRIEF DESCRIPTION OF THE DRAWINGS

The invention is subsequently explained as an example and in more detail by means of two schematic drawings. In the drawings:

FIG. 1 shows a view of a passenger motor vehicle,

FIG. 2 schematically shows a design in a vehicle

FIG. 3 shows a view on the switchboard of a vehicle from the interior,

FIG. 4 shows an alternative design in the vehicle.

### DETAILED DESCRIPTION OF THE DRAWINGS

In the following description of the figures, the forward direction of the vehicle is denoted with the front, the rearward direction of the vehicle is denoted with the rear, the right side of the vehicle seen in the forward direction is denoted with the right side, and the left side of the vehicle seen in the forward direction is denoted with the left side of the vehicle.

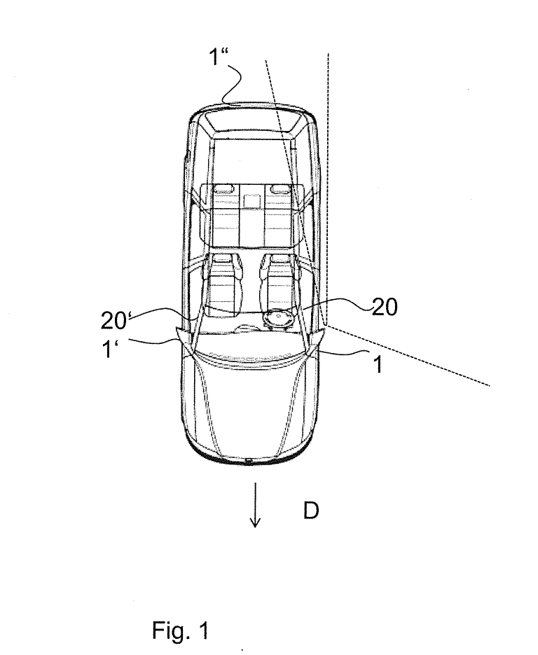

According to FIG. 1, on a passenger vehicle shown in the view, whose forward direction is indicated in the figure by arrow D, an electronic camera unit 1, 1′ is attached in each case in the region of the front bodywork pillars on the side 20, 20′, whose field of view towards the rear covers an angle α and α′ respectively. The solid angle covered is shown by dotted lines, whereby the inner limit is a line, which is inclined against the longitudinal centre line of the vehicle, and whose outer limit forms an angle of approximately 10 to 90 degrees with the longitudinal direction of the vehicle. The camera has a wide-angle lens, which is in the position to cover a wider area than that which would be included by a mirror. In addition, wide-angle lenses or lenses are used so that the image detail, which the camera is allowed to view, is thus predetermined. The design can be configured according to the selection of lenses, according to whether the simple view of a classic mirror should be reproduced, or if a much wider area is desired for a representation of the bird's eye view. Fish-eye lenses can definitely be used here, which allow a view of 180 degrees and more.

In this execution example, the cameras are attached approximately in the position of the exterior rear view mirror. Through this,—with appropriate evaluation—one obtains an angle and an image resulting from it, which approximately corresponds to the familiar reflection. However, for the execution of the invention, the exact attachment of the cameras to the vehicle is not significant.

In this example, there is another camera 1″ at the rear end of the vehicle, which covers the region behind the vehicle and whose image is represented in a display on the interior mirror area.

The image collected by each camera unit is converted in a known way, and is forwarded to a display screen in each case.

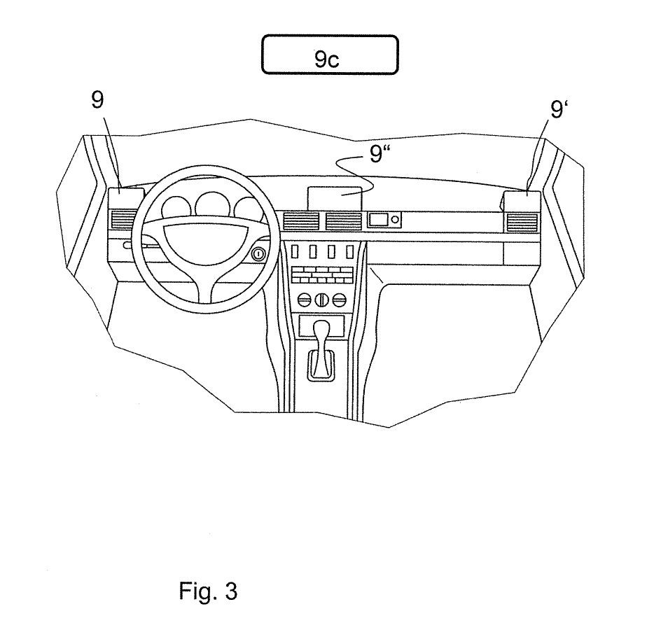

FIG. 3 shows a view on a switchboard of a vehicle with display screens 9, 9′, which are attached on each side of the switchboard in the region of the A-pillars 20, 20′, whereby the display screen on the left is assigned to the camera unit on the left, and the display screen on the right is assigned to the camera unit on the right.

In the example shown, the switchboard has a further display screen 9″ in its central region, for a vehicle navigation system, for example, or as an exclusive display screen, if the display screens 9 and 9′ are not installed, and both rear views are integrated in one display screen.

A further display screen 9c can show the image of the rear camera instead of the interior mirror. In the process, its position is the mounting location of a classic interior mirror.

The design of the electronic camera units and electronic control system, in which the processing of the images collected by the electronic camera units also takes place, is known, and therefore not explained in detail. It is not mandatory that the electronic control system is included in one unit, but rather distributed over several components in the vehicle, and at least partly integrated with other components.

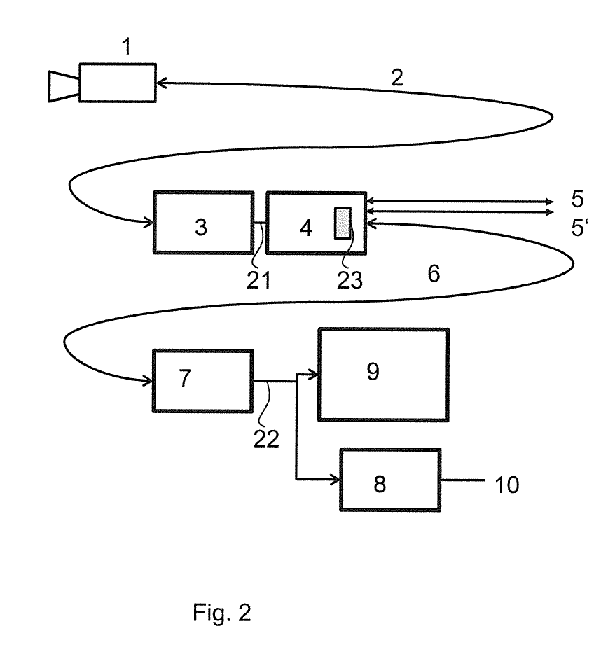

FIG. 2 shows a typical design of a system according to the invention, under realistic installation conditions in a vehicle. A camera, which consists of an optical sensor with appropriate recording optics, is attached on the external side of the bodywork of the vehicle.

The optical sensor is, for example, sensor technology with a charge-coupled device (CCD) or with a complementary metal oxide semiconductor (CMOS) for recording continuous real-time images.

Advantageously, colour sensors are used in the mirror replacement for the representation of the environment.

Using HDR High Dynamic Range technology has been shown to be advantageous for the high dynamic differences, in order to compensate for under and overexposures.

The signal of sensor 1 is sent from one driver, which is situated on the same circuit board, or is at least spatially adjacent. In doing so, the format of the data is preferably an unprocessed signal such as “RAW”, in which case the camera transfers the data largely without processing after digitalisation.

By using the non-interpolated sensor data with 10, 12 or 14 bit per pixel, a larger dynamic range and a more exact brightness resolution is given. The values of image areas, which are not too under or overexposed, are still mostly available in useable form. All details recorded by the image sensor are fully preserved.

As long as the bandwidth of the subsequent transmission is sufficient, RAW data is advantageous.

However, the solution according to the invention can also be realised with RGB signals or YUV signals. Here again, the data is still not compressed.

The image refresh rate, with the abbreviation fps (frames per second) denotes the number of (changing) images per second in video recording, as well as in graphic computer applications.

The human brain perceives consecutive images from approximately 14 to 16 images per second as apparently moving scenes, which is why the image frequency in normal displays such as television is 25 fps. An image refresh rate of 30 fps allows very good image reproduction. For use in the automotive industry, the image sensor must work at high speeds and under difficult lighting conditions. Illumination devices of vehicles, in which pulsed LEDs are operated, as well as stroboscopic warnings, represent a particular challenge here. Therefore, in the longer term, a slightly higher image rate is particularly preferable.

The optical sensor is connected to a receiver circuit board 3 with a star quad (twisted quad cable). On the receiver circuit board, the signal is converted from serial data back to parallel data. The star quad belongs to the symmetrical copper cable. In the star quad cable, four wires are stranded together crosswise. This means that the opposite-facing wires form a pair of wires in each case. In the process, it is advantageous for the transmission of signals to code an LVDS (Low Voltage Differential Signalling) signal on two wires lying crosswise. The signal is therefore robust against disturbances. Both remaining wires of the quad cable are used for power supply. For the transmission, other codings such as CMS (Current Mode Logic) or complex codes such as LVPECL (Low-voltage positive emitter-coupled logic) or LVCMOS (Low Voltage Complementary Metal Oxide Semiconductor) can be used.

The four wires stranded together are surrounded by a common protective casing, which can include a mesh or foil screening. This mechanical design determines the transmission parameters such as the cross-talk, the attenuation-cross-talk relationship or the near-end cross-talk.

The main advantage of a twisted quad video transmission is the large transmission distance which can be reached. Transmissions of up to 150 m are theoretically possible, and this type of transmission is therefore well suited for a vehicle. In practice, the transmission length is not greater than 10 m, which leads to a secure and reliable transmission of data without interference.

The receiver circuit board 3 can therefore be attached in any position in the vehicle at a great distance from the optical sensor. The receiver circuit board is preferably mounted in the doors or under the dashboard. It must be ensured that no moisture enters the vehicle doors. The receiver circuit board is subjected to large vibrations and shakes, for which it must be designed. The receiver circuit board 3 is connected by a parallel data cable 2 to an image evaluation circuit board 4, which contains a digital signal processor DSP. The image evaluation circuit board 4 has processing capacities, which are produced by a computation unit, such as a DSP, for example, a field programmable Gate-Array (FPGA), micro-processors or application-specific circuits (ASICs) or a combination thereof, which have programming capabilities, for example, by a machine-readable medium such as software or firmware, which is recorded in a microprocessor, including ROM (Read Only Memory), or as binary data, which can be programmed by a user.

The image evaluation circuit board 4 has further interfaces, which serve to receive data of the bus system present in the vehicle, such as the widespread CAN bus, LIN bus, or a combination thereof. These interfaces 5 serve to take additional data of the vehicle, and to provide it for further processing in the software, which runs on the DSP. The CAN bus does not transmit only vehicle data, but rather can also be used for reciprocal communication of the module, e.g. verification of detected objects, or similar, programming of the module via PC, or for transmission of parameters via PC.

A further interface 5′ serves for issuing a signal, which contains a warning. In the process, the warning signal is transmitted to a warning device, which is a warning light such as a flashing LED, or triggers a verbal warning over the radio or a warning tone or over the Can bus, a control of a vibration motor in the steering wheel or in the seat.

The interfaces 5 and 5′ also serve for day/night setting of the display. The ‘day’ or ‘night’ decision can be made using the image evaluation. The result is then given on the display 9 via the vehicle bus or via a separate cable, in order to regulate the brightness of the display. In the process, the regulation takes place in approximately 100 stages, so that a fine dimming down or turning up of the display can take place.

The image evaluation circuit board 4 includes a further driver, which serialises the parallel data, and prepares for a transmission via a further twisted quad cable.

The evaluation of the image data takes place with suitable software on the image evaluation circuit board 4. The image data is pre-processed on the image evaluation circuit board 4. In any case, rectification of the image data, produced by the wide-angle lens, takes place on the image evaluation circuit board 4. This processing function generates an image of the camera, which is sufficient for representation on a display screen. The DSP 23 is configured so that it can still carry out additional functions. The image data is analysed according to additional driver assistance tasks, in order to fulfil the warning and information task for an assistance system such as a lane change assistant, lane departure warning assistant, reversing assistant, bird's eye view, pre-crash sensor, recognition of traffic signs, blind-spot monitoring, as well as other warning systems, which relate to optical image processing.

Since the camera sensor 1 has a higher resolution than the display 9, only a section of the total image recorded is shown on the display. Therefore, the image section is selected on the image evaluation circuit board 4, which can also move along the whole image, and thus simulates a camera movement. This image processing in DSP 23 is advantageous for reversing. The image section is focused on the rear wheel, for example. Otherwise, the image section can be adapted to the personal customs of the driver, or to the requirements of legal regulations.

For evaluation of the image data, it is important to process the images occurring successively in time without delay. Therefore, it is not possible to permit a distance greater than 100 mm between the receiver circuit board 3 and the image evaluation circuit board 4. The connection between both circuit boards 3 and 4 is via parallel data cables. It is also possible to accommodate both functions, which for example are distributed over two circuit boards, on one board. The serial signal passes to a further receiver circuit board, to the display receiver circuit board 7, via the twisted quad (TQ) connection 6. This again converts into parallel data and sends it via a data connection 22 to the closely adjacent image circuit board with the display 9. Parallel to this, the video data is sent to a test circuit board 8 and co-written over the interface 10 by a PC or recorder. The test circuit board 8 receives the processed data of the image processing circuit board 4 as parallel data pixel by pixel, so that the image can be checked for errors. The data material can be evaluated by special software in order to correct the system. This function is no longer necessary in the case of a series product, but the data output is then used for cyclical writing of the image data on a storage medium, and thus integrates a tachograph function.

As the length of the connections 2 and 6 is non-critical, the circuit boards and components can be placed in a suitable position anywhere in the vehicle. It is advisable that the connecting lengths are between 1 m and 5 m, but in individual cases can also be longer, up to a distance of 10 m. In the process, it is important that the serial data is transmitted over a long length for a vehicle, but the parallel data, however is always directly transferred via internal data cables and short distances up to 100 mm.

The representation of the image data on the display takes place in real time. As an added value, assistance functions such as warning signals, traffic signs, colouring of an image section, highlighting a contour etc. are superimposed on the image.

In the process, the present image data is evaluated with regard to different parameters, such as object detection and classification of the detected object into classes of risk. A blind spot display can therefore be implemented, which only reacts when approaching large objects. If this is the case, there is an acoustic and/or optical warning, for example. The particular vehicle can be clearly marked in the image display, by red colouring and flashing, for example. The operator is then warned and refrains from turning. In addition, the blind spot display can be supplemented by evaluation of vehicle data, such as the angle lock of the steering wheel, or the activation of the turn signal control, and improved by this.

A pre-crash sensor simultaneously requires the speed data of the approaching object, in order to deploy an airbag, as the case may be, before acceleration or deceleration can be measured on the vehicle itself.

A collision warning before a rear impact is also possible, given that the corresponding security systems can be activated in the vehicle, or the vehicle can accelerate in order to avoid a rear impact, if the front sensors allow this.

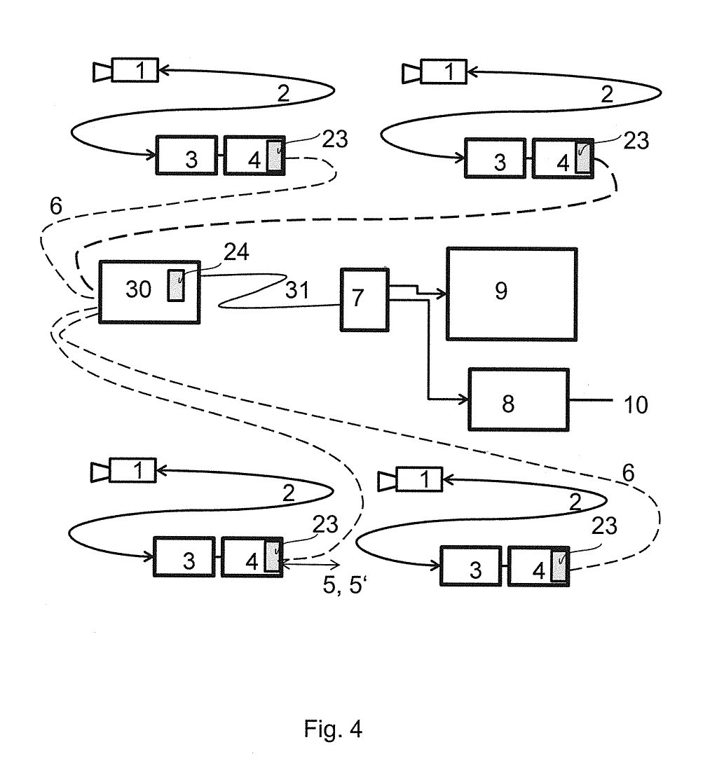

FIG. 4 shows an embodiment with more than one camera sensor. The components and functions here correspond to those designs in FIG. 3.

The image data of the four cameras is connected to a multiple receiver circuit board 30 via cables 6, which are shown here as dashed for ease of differentiation. Four receivers decode the LVDS data, and a DSP 24 processes the data in a second process step. The data is forwarded, again in serial, via the output and a further long connection cable 31, to the display receiver circuit board 7 and to the display. It is therefore possible to show four individual images, which can be seen on a single display consecutively or in a separate presentation, or however, forwarded to more than one display 9, 9′, 9″. The connection cable 31 connects the serial output of the multiple receiver circuit board 30 with the input of the display receiver circuit board 7. The connection cable separates the second processing step of the camera image from the actual presentation on the display.

In an advantageous embodiment, two cameras sit in exterior mirrors, which are still present, or on this mounting position. The first variable data connection 2 leads into the boot of the vehicle, in which the receiver circuit board 3, the image evaluation circuit board 4 and the multiple receiver circuit board 30 are situated. The display receiver circuit board 7 and the display 9 are controlled by the variable data connection 31, which is situated in the view of the driver in the interior.

In this embodiment, the image data of the four cameras is fed through further processing. After its individual processing on the image evaluation circuit boards 4, the image data is subjected to a further second processing. An additional processor 24, which compiles the image data to a general view with a perspective from above, is situated on the multiple receiver circuit board 30. This compiled file is shown on the display 9. With four camera sensors, not only can a bird's eye view image be generated, but also the above named functions of blind spot monitoring. A view towards the rear is also possible with the use of fish-eye lenses, and functions such as the lane change assistant, cross-wise traffic monitoring, reversing camera etc. can be implemented.

The invention is not limited to the design with separate circuit boards. The named receiver circuit boards can be integrated into the boards connected with data cables, so that a unit is formed. The modules 2 and 4 are therefore integrated on a common board, as well as the modules 7 and 9.

If necessary, the evaluation board 8 can also be integrated into this.

1. (canceled)

2. Motor vehicle rear view device according to claim 16, wherein said connection cables are twisted quad cables.

3. Motor vehicle rear view device according to claim 16, wherein serial data of an image signal is coded for transmission with a transmission coding.

4. Motor vehicle rear view device according to claim 16, wherein said image evaluation circuit board contains a programmable processor.

5. Motor vehicle rear view device according to claim 16, wherein said programmable processor of the image evaluation circuit board rectifies the image data.

6. Motor vehicle rear view device according to claim 16, wherein said programmable processor of said image evaluation circuit board additionally subjects the image data to an image evaluation for hazardous situations or information situations.

7. Motor vehicle rear view device according to claim 16, wherein said image evaluation circuit board includes a plurality of interfaces.

8. Motor vehicle rear view device according to claim 16, wherein each of said plurality of interfaces serve as a connection to a bus system of the motor vehicle or to a warning device.

9. Motor vehicle rear view device according to claims 16, wherein image data of said display receiver circuit board is connected to a test circuit board via said data cable.

10. Motor vehicle rear view device according to claim 16, wherein said test circuit board prepares data for evaluation and/or recording via a test circuit interface.

11. Motor vehicle rear view device according to claim 16, including a multiple receiver circuit board, which is connected to said image evaluation circuit board, contains a further programmable processor.

12. Motor vehicle rear view device according to claim 11, wherein said multiple receiver circuit board includes a programmable processor and brings together image data from a plurality optical sensors.

13. Motor vehicle rear view device according to claim 16, wherein said display shows image data in a bird's eye view.

14. Motor vehicle rear view device according to claim 16, wherein a multiple receiver circuit board is connected to the display receiver circuit board via a further connection of 2 to 10 m in length.

15. Motor vehicle rear view device according to claim 16, wherein the image data of the optical sensor are RAW-RGB signals or YUV signals.

16. Motor vehicle rear view device for use with a motor vehicle, said motor vehicle rear view device comprising:
an image evaluation circuit board fixedly secured within the motor vehicle;
a receiver circuit board electrically connected to said image evaluation circuit board;
a display electrically operatively connected to said image evaluation circuit board through said receiver circuit board;
an optical sensor electrically connected to said image evaluation circuit board, said optical sensor receiving light and producing optical output signals based thereon to be displayed on said display;
circuit board connection cables electrically connecting said image evaluation circuit board and said receiver circuit board, wherein said connection cables provide a serial connection for serial data having a length between 1 meter and 10 meters; and
data cables electrically connecting said receiver circuit board and said display, said data providing a parallel connection for parallel data and extending a length less than 100 mm.
